(19) United States
(12) Patent Application Publication
(10) Pub. No.: US 2008/0151552 A1
(43) Pub. Date: Jun. 26, 2008

(54) Lamp lite

(75) Inventor: Theresa Marie Bextermiller, St. Louis, MO (US)

Correspondence Address: THERESA MARIE BEXTERMILLER, 1120 BLENDON PLACE, ST. LOUIS, MO, 63117-1911, US

(73) Assignee: THERESA MARIE BEXTERMILLER, St. Louis, MO (US)

(21) Appl. No.: 11/585,323

(22) Filed: Oct. 24, 2006

(51) Int. Cl. F21V 3/00

(52) U.S. Cl. 362/311

(57) ABSTRACT

Metal ornamental body for a hanging (ceiling) light (single white light bulb) fixture consists of three possible units—single (in red), double (in green), corner (in blue), with a more complex unit(s) possible. The three metal wire units are all derived from six modular pieces that slot and/or join together with metal rods, some wrap-around. These simple, inexpensive units are groupable and portable. Designed, used and installed per current National Electrical Code, the standard lamp light bulb socket/wire/wall plug assembly is sold and/or packaged separately, although in the same box, and/or accessories can be bought separately at any hardware store. For instance, additional cord chain, or ceiling support, or switches can be purchased separately or additionally, or offered alongside the product unit boxed packages. ‘Lamp Lite’ packages, posters, postcard, logos, light units and all designs and colors are with the digital world in mind: R 255+G 255+B255=white light.

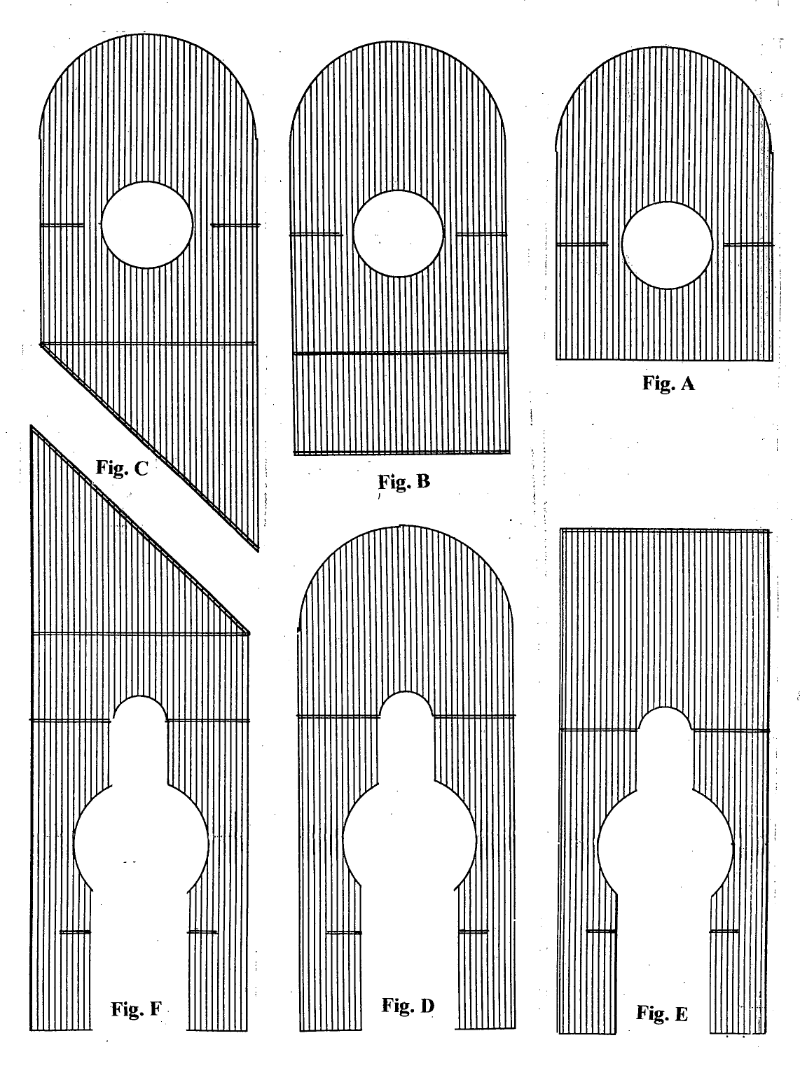

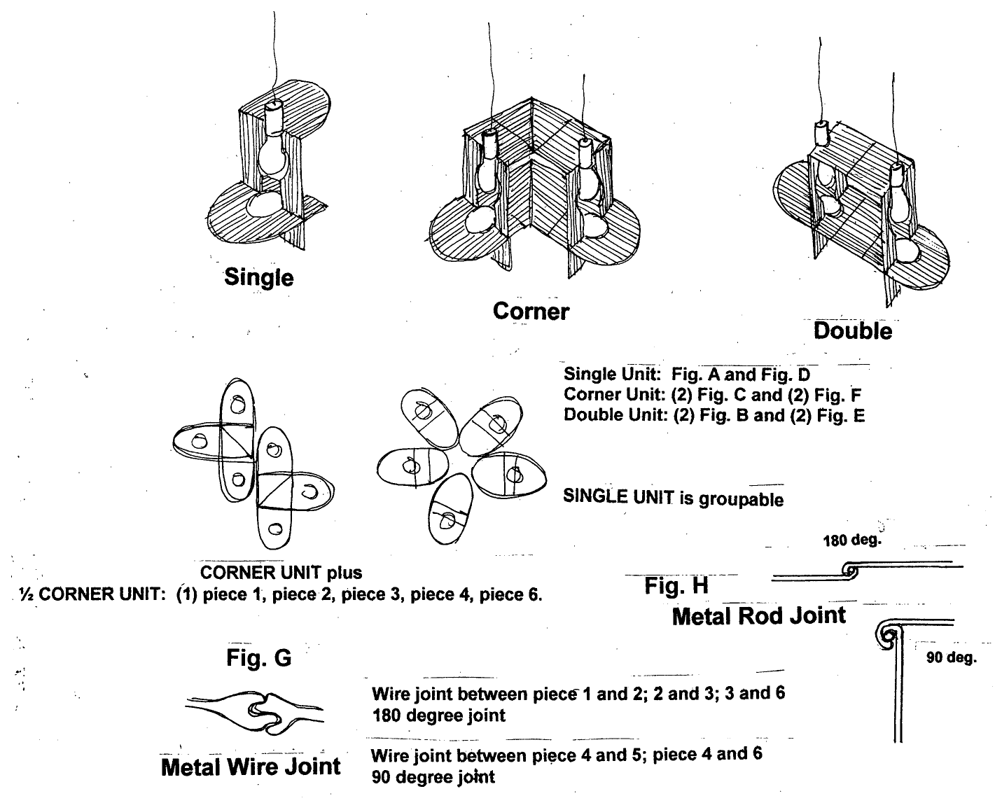

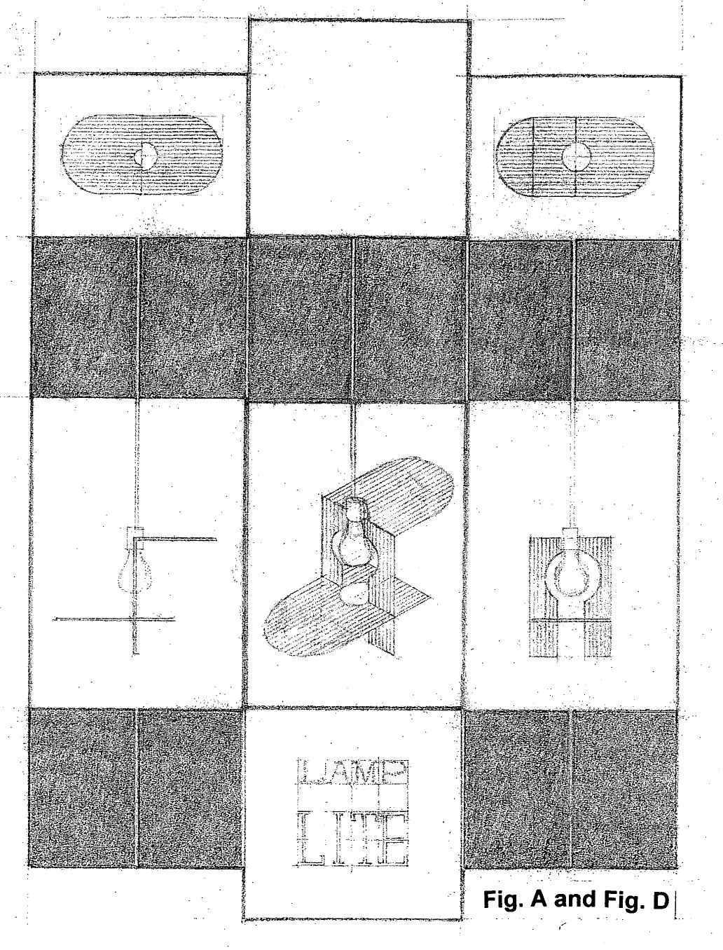

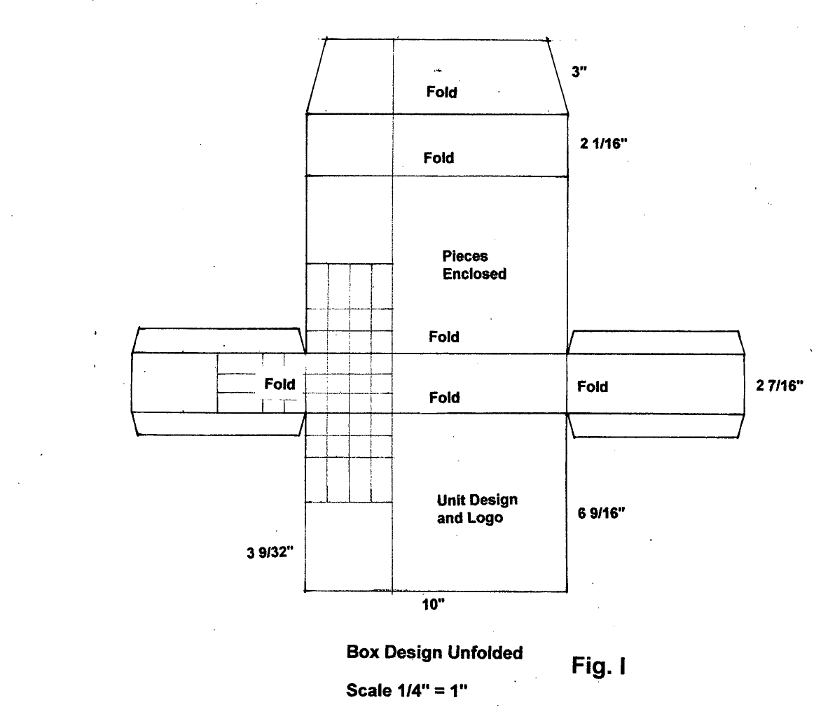

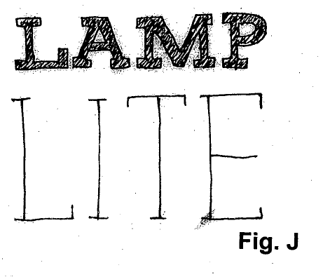

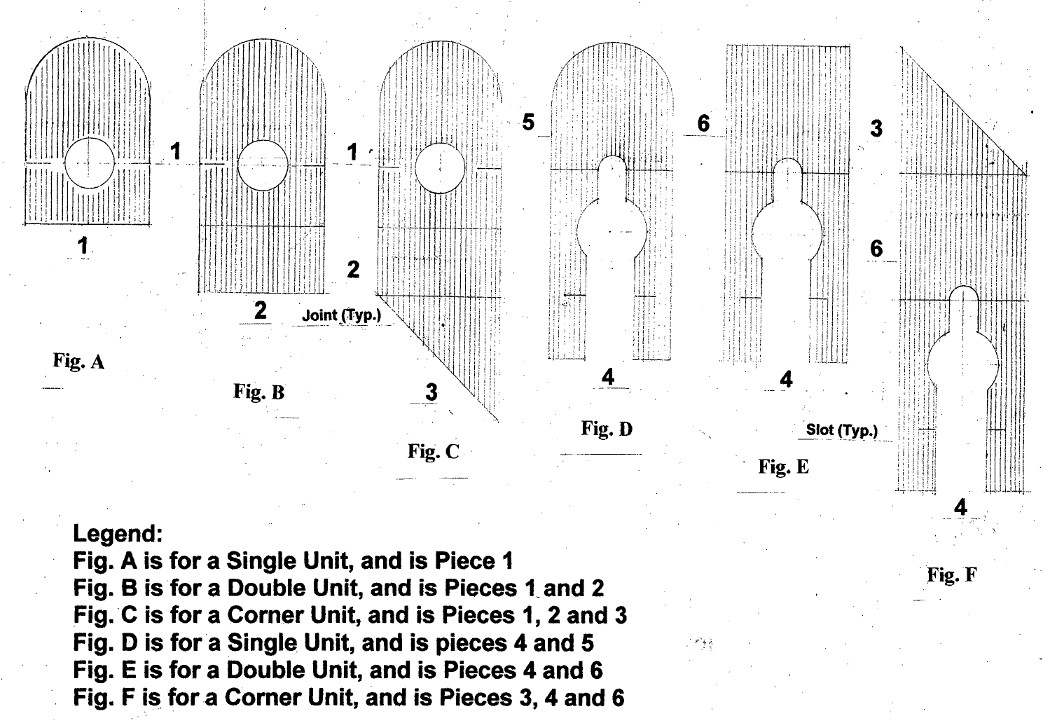

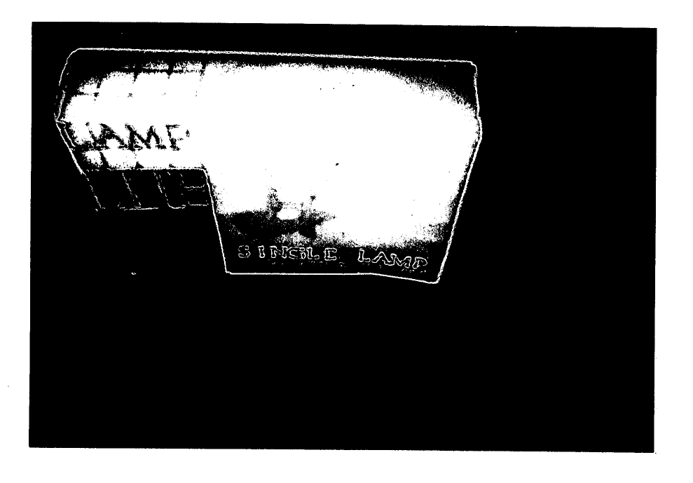

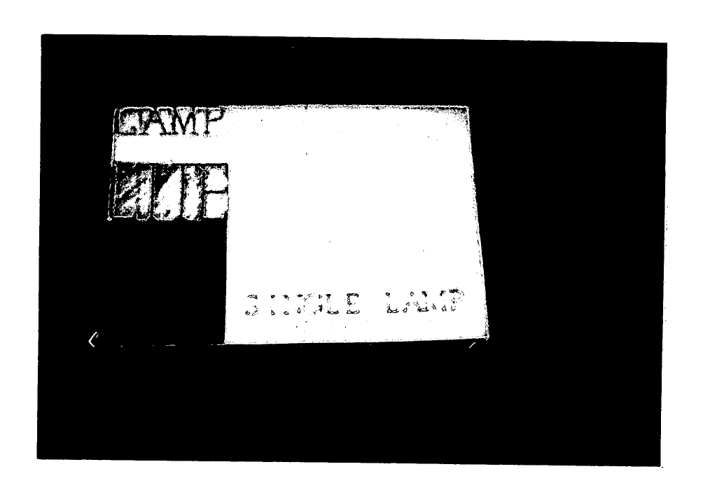

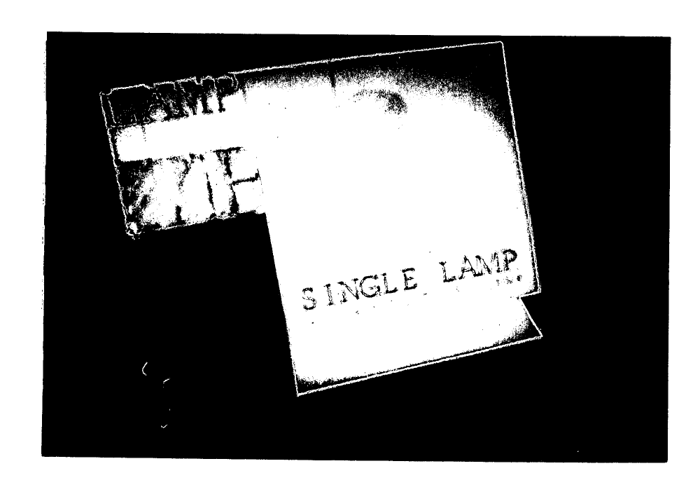

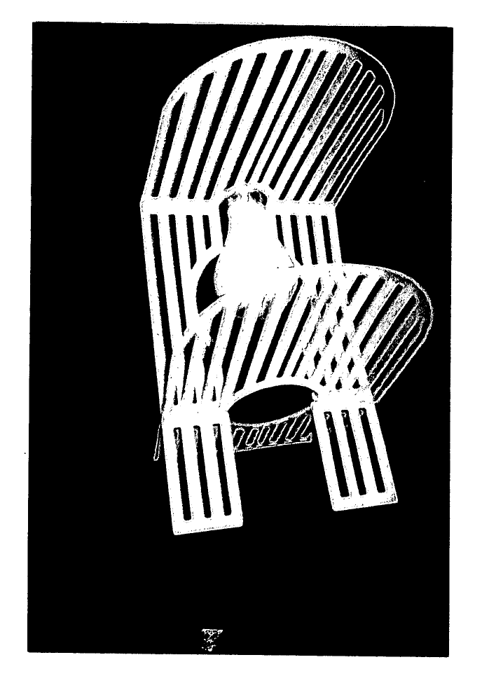

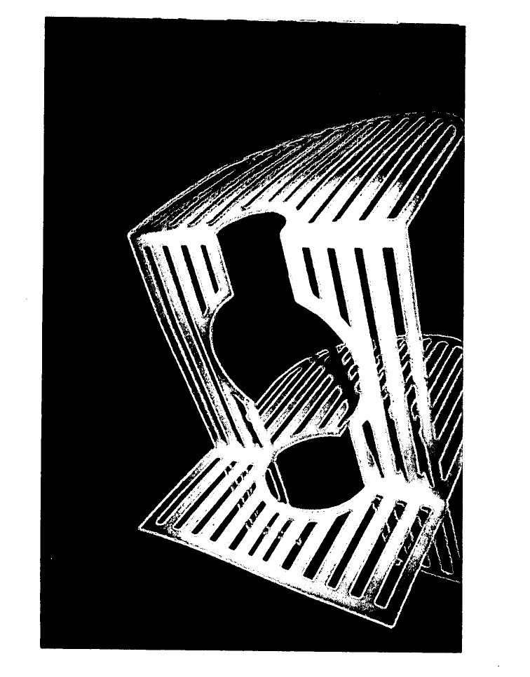

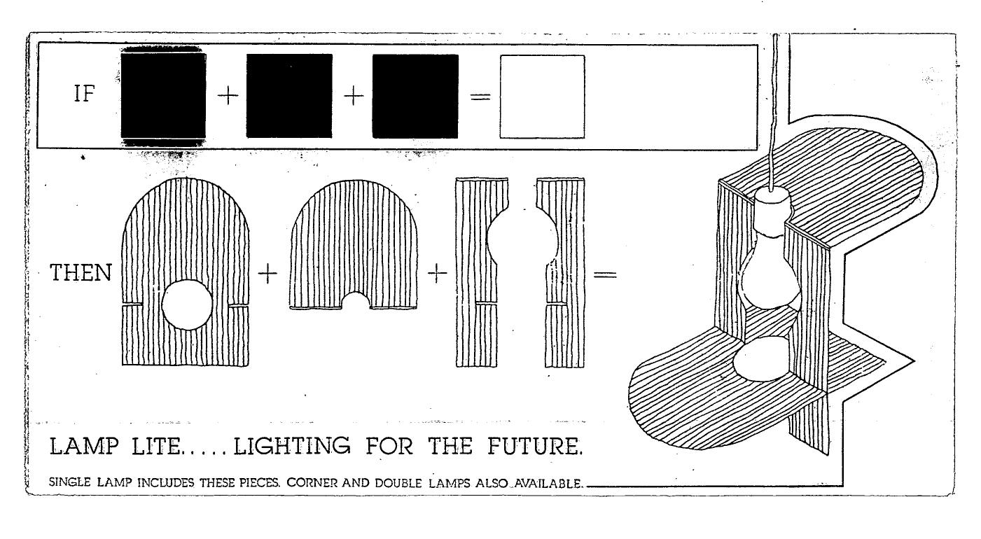

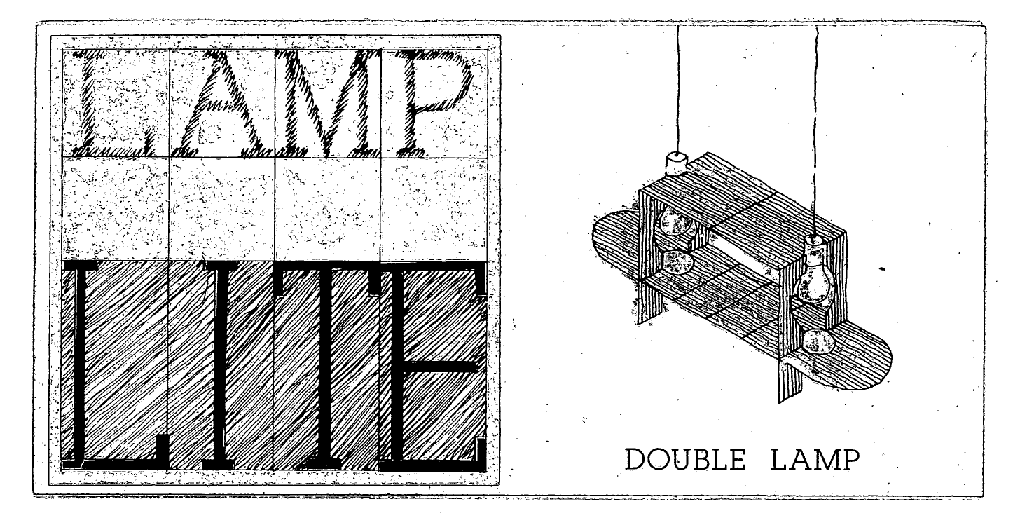

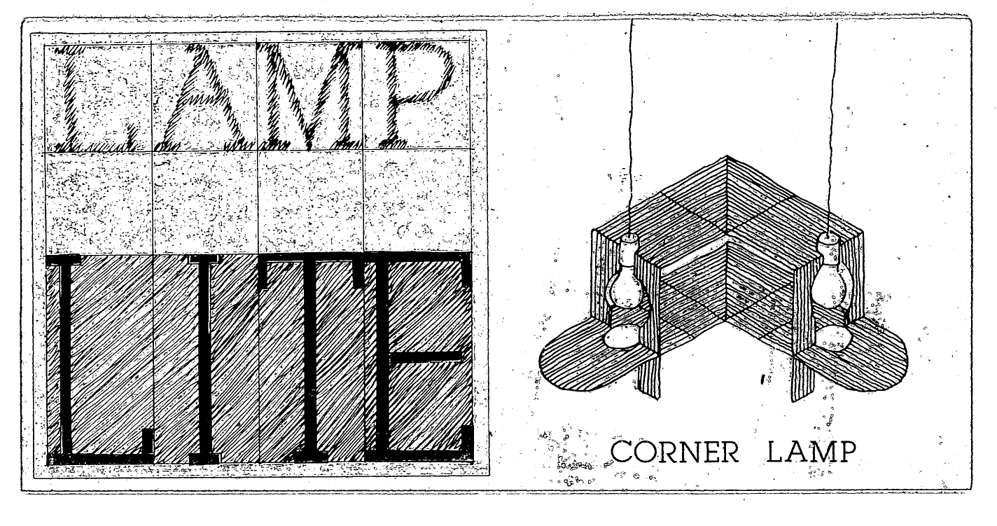

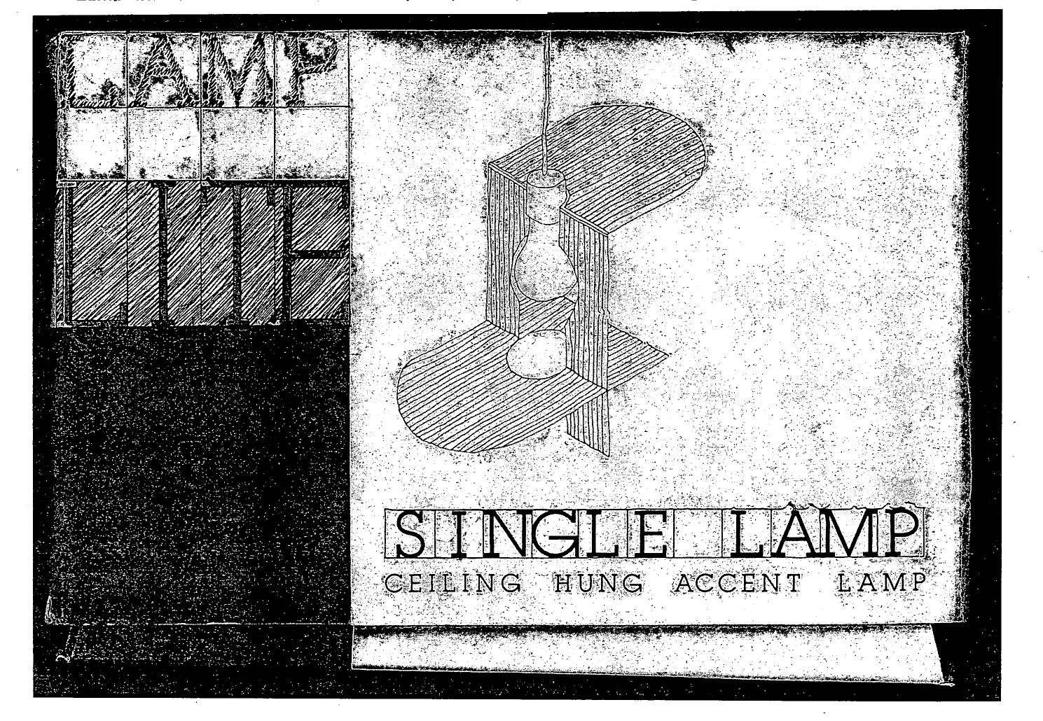

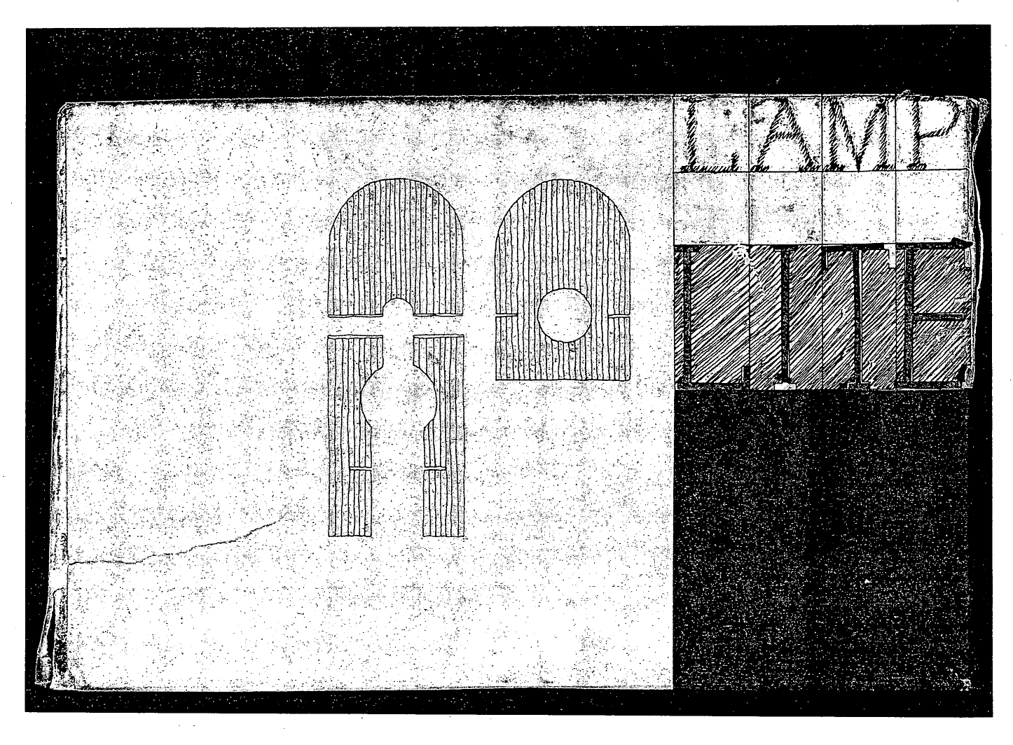

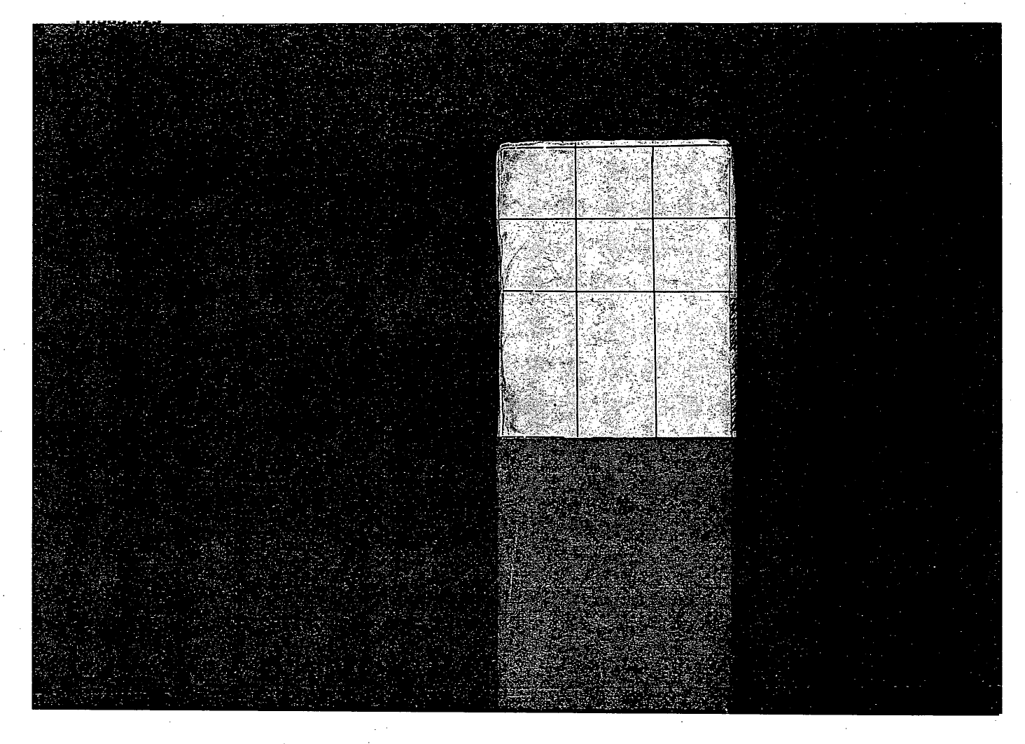

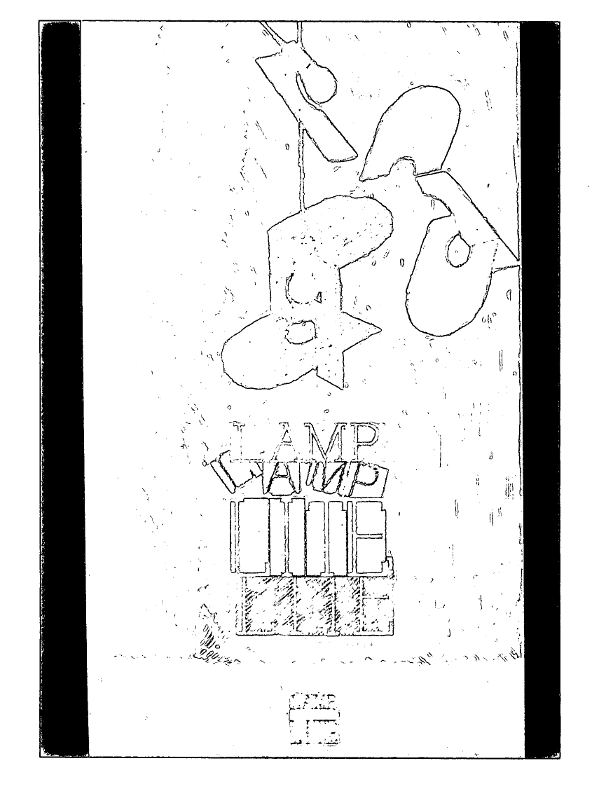

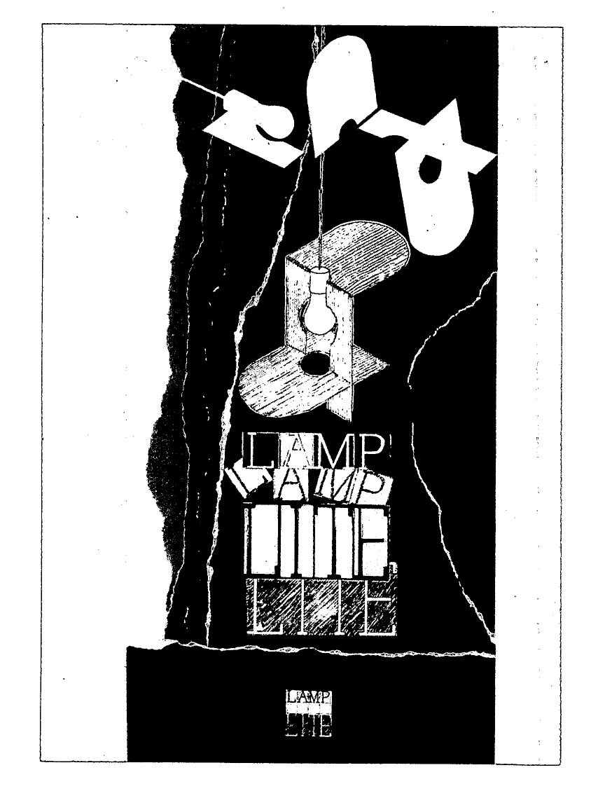

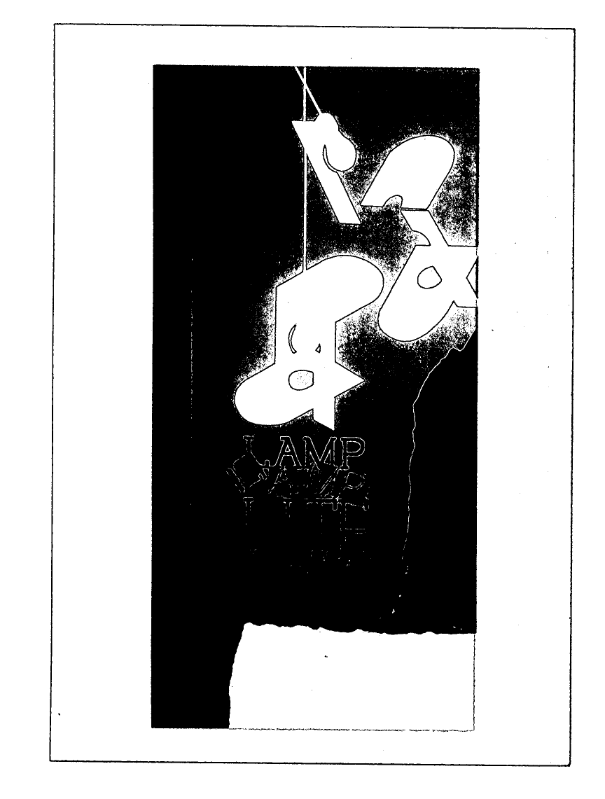

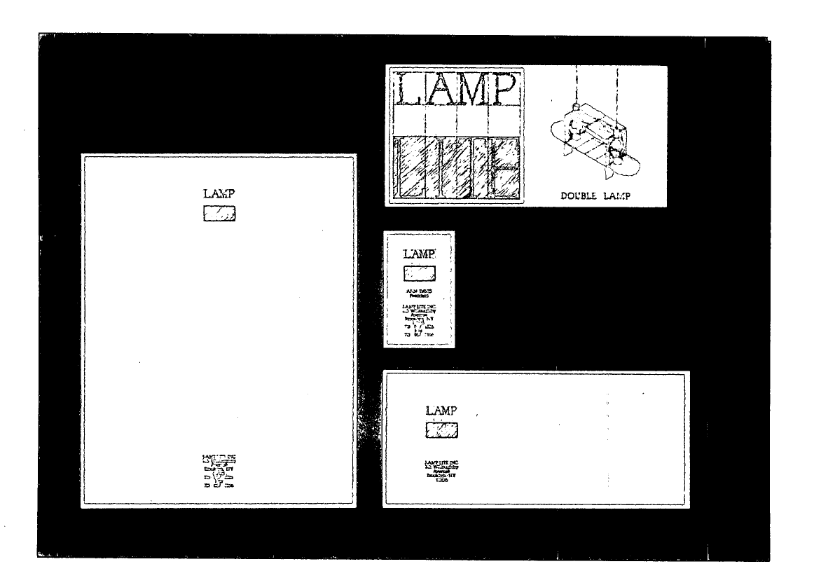

### CROSS-REFERENCE TO RELATED APPLICATIONS

I found at Bed Bath & Beyond in Brentwood, Mo., in August, 2007, an item called ‘Tassel Pendent Lamp’, on clearance for $2.99, was $9.99, which is UL Listed, Portable Luminaire, issue no. BK 38,584, dated November 2005. The product says on the hanging clear plastic package: “Includes 1 tassel lamp with 15′ cord kit . . . in-line switch . . . 15″ tall . . . 40-watt maximum type A lightbulb (bulb sold separately) . . . indoor use only”. The package corner reads: “Equip your space!”, and the tassels were in different colors, including purple and teal. There is included a single white paper page “Assembly Instruction Sheet”, and the steel framed product was made in China. There is a Patent Pending on the in-line switch: “3A 120VAC J-10 SPT-2 PAT. PENDING SUN-LITE SOCKETS IND” written on one side; on the other side: 77HF E208228 UND LAB INC LIST THRU-CORD SWITCH”.

I have not seen anything this closely resembling the ‘Lamp-Lite’ product on the market before.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

I intended to design a simple, affordable hanging light fixture body for, anyone. Because of the importance being gained by computers in everyday life, I concentrated on a modular design comprised of a few parts. Many people do not understand the complexity of computers, and, so, I concentrated on designing a utilitarian light body that showed understanding of the computer. Lighting around computers, while the computers are being used, is still being studied. Computer placement; wiring and electrical outlet placement; seating and desk design and placement are room design factors, and thus other subjects, but the design of light fixtures seems to be still very simple and traditional. The parts of light fixtures are covered under a few, known, patented designs.

This light fixture body was designed in 1989 in New York City. I am from the St. Louis, Mo. area. The copper, metal model that I built in 1989 does not exist anymore. I soldered the metal parts together, and the model was not stored properly, and fell apart.

Because white light is becoming more prevalent, I saw a market for a safe, metal enclosure for the everyday light bulb. This enclosure, on a table lamp, is called the ‘shade’. Shades are removeable and interchangeable from table lamp to table lamp. Shades are made of plastic, and can be covered with fabric. They can, also, be glass, or metal, on rare occasions. Glass or metal shades can be included in traditional cylindrical table lamps, and are seen in floor lamps. I designed a hanging light fixture body for a light bulb that will be shining down from a higher place, and will be placed near a ceiling; or in a corner of a room midway down; or above a dining table, above seated eye level. The light fixture body is not permanent, and is not designed to be a permanent part of the architecture.

### BRIEF SUMMARY OF THE INVENTION

The design of the hanging light fixture body, or ceiling hung light fixture body, does not include screws or nuts. One does not need a screw driver to put the body together. There could be plastic parts—the six pieces could be built from hard plastic, with the same positive-negative joints and slots. This would not be as durable and/or fire-safe in design as metal. For the design in this application, I am choosing metal and aluminum for the pieces. More expensive materials could be used, such as brass or sterling silver, for a specialized Lamp-Lite product. The main idea of the design is for the product to be inexpensive and portable, therefore, I am choosing the least expensive, more common materials in this application.

Appropriate lighting levels and the effects of different light levels on computer users are subjects of study. Placement of appropriate light around computers, for many people, is a subject of study. The effects of different light placements vary with individuals and their age, weight, and health. The light bulb in this hanging light fixture body could be-of any design or wattage, but small wattage would seem to be safer, since the fixture is moveable. Because small wattage suggests grouping the units, there would have to a safe number of electrical outlets in the room in which they are placed. Older buildings have a limited number of electrical outlets, and this fact brings up an architectural problem that needs to be addressed in our society. Hopefully, other inventions will help in re-use or adaptation of existing electrical systems that are out-of-date or insufficient.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

PAGE 01 plan of the modular, interchangeable body pieces—⅓″=1″

PAGE 02 drawing of persective assemblies of the pieces, showing interlocking, rotatable wire joint

PAGE 03 dwg. of single unit conceptual poster design—actual size

PAGE 04 unfolded plan of box for unit pieces—scale ¼″=1″

PAGE 05 drawing of type study for Lamp Lite title logo

PAGE 06 dwg. of pieces with their numbers beside them—scale 3/16″=1″

PAGE 07 photograph of single unit box—front or top side

PAGE 08 photograph of single unit box—back or bottom side

PAGE 09 photograph of single unit box—open

PAGE 10 photograph of white cardstock model, single unit assembled—view one

PAGE 11 photograph of white cardstock model, single unit assembled—view two

PAGE 12 color copy—postcard design for single unit—80% of actual size

PAGE 13 color copy—logo design for double unit—actual size

PAGE 14 color copy—logo design for corner unit—actual size

PAGE 15 black and white photocopy of box design—front

PAGE 16 black and white photocopy of box design—back

PAGE 17 black and white photocopy of box design—side

PAGE 18 color copy of preliminary poster design—red and brown

PAGE 19 color copy of poster design—red and brown

PAGE 20 color copy of poster design—yellow and gray

PAGE 21 color copy of envelope, stationery, business card and logo for double lamp designs

The application file contains at least one drawing executed in color. The drawings are covered under U.S. Copyright granted in 2002—I was advised to seek a patent on Dec. 10, 2001, in a letter from the Copyright Office, Visual Arts Section.

On all drawings, especially PAGE 01 (Macintosh software sketched on a grid, 8.5×11 inch sheet) and PAGE 06 (hand drawn):

Fig. A: Single Unit

Fig. B: Double Unit

Fig. C: Corner Unit

Fig. D: Single Unit

Fig. E: Double Unit

Fig. F: Corner Unit

Fig. A: Piece 1

Fig. B: Piece 1 and Piece 2

Fig. C: Piece 1, Piece 2 and Piece 3

Fig. D: Piece 4 and Piece 5

Fig. E: Piece 4 and Piece 6

Fig. F: Piece 3, Piece 4 and Piece 6

SINGLE UNIT: Piece 1, Piece 4 and Piece 5

CORNER UNIT: (2) of Piece 1

(2) of Piece 2

(4) of Piece 3

(2) of Piece 4

(2) of Piece 6

DOUBLE UNIT:

(2) of Piece 1

(2) of Piece 2

(2) of Piece 4

(2) of Piece 6

Drawing PAGE 02

Single Unit Fig. A and Fig. D

Corner Unit: (2) of Fig. C and (2) of Fig. F

Double Unit: (2) of Fig. B and (2) of Fig. E

MORE COMPLEX units are possible by adding more pieces.

MORE COMPLEX units:

CORNER UNIT plus

½CORNER UNIT: (1) of Piece 1, Piece 2, Piece 3, Piece 4, Piece 6.

Units are GROUPABLE.

SINGLE UNIT is GROUPABLE—multiple, for instance five, of the SINGLE UNIT can be hung forming a circular array.

### DETAILED DESCRIPTION OF THE INVENTION

Plan Scale: ⅓″=1″, or 1″=3″.

The middle light bulb hole is 3½″ DIAMETER; the light hole is 2½″ DIA.; the light hanger hole is 1½″ DIAMETER.

The light fixture body is 6″ wide.

The unit pieces are either 3″, 6″ or 9″ in length.

The spacing of the metal or aluminum wire depends upon the thickness and weight of the wire.

The outside edges of the pieces, and the joints, are heavier, although still lightweight, bent and/or bendable metal rods.

WIRE JOINT between piece 4 and 5; piece 4 and 6—Fig. G:

90 DEGREE JOINT: Metal rod insert for expansion and contraction—Fig. H. Wire joint soldered joint piece with separate metal rod insert stabilizing piece—Fig. G., Fig. H.

WIRE JOINT between piece 1 and 2; 2 and 3; 3 and 6—Fig. G:

180 DEGREE JOINT:

Wrap-around top and bottom of both pieces metal rod insert for stabilization, expansion and contraction—Fig. H.

The wire joint metal rod insert is three times as long at the 180 degree joint so that the insert can be wrapped around over the top, as well as going through the soldered joint—Fig. H.

SINGLE UNIT: 6 inch metal rod insert—Fig. H:

CORNER UNIT: (2) of 6 inch metal rod inserts; (2) of corner 12 inch wrappable metal rod inserts; (6) of 18 inch wrappable metal rod inserts—Fig. H.

DOUBLE UNIT: (2) of 6 inch metal rod inserts; (4) of 18 inch wrappable metal rod inserts—Fig. H.

Drawing PAGE 03

Poster design—Fig. A and Fig. D:

Modular pieces, colored appropriately, designed on a regular, repeating grid—3 pieces shown for SINGLE UNIT. The light bulb on a cord is attached to pieces 4 and 5 at the joint. Pieces 1 and 4 are slotted together forming a tight 90 degree joint. Per National Electrical Code (N.E.C.) 2005 (latest edition now N.E.C. 2008): light bulb is hung by a separately packaged electrical cord attached to a separately packaged electrical socket.

Drawing PAGE 04

Packaging—FIG. I:

SINGLE UNIT: Cardboard box 10 inches by 6 9/16 inches by 2 7/16 inches. Three pieces shown on the back, perspective drawing on the front in RED and WHITE colors—FIG. I.

CORNER UNIT: Cardboard box 20 inches by 6 9/16 inches by 7 5/16 inches. Five pieces on the back, perspective drawing on the front in BLUE and WHITE colors.

DOUBLE UNIT: Cardboard box 20 inches by 6 9/16 inches by 4 14/16 inches. Four pieces on the back, perspective drawing on the front in GREEN and WHITE colors.

Drawing PAGE 05—Fig. J:

Text in CAPS on packages in LUBALIN GRAPH, Extra Light and Demi typeface design, with crosshatching on the word ‘LAMP’.

Drawing PAGE 07—COLOR PHOTOGRAPH OF SINGLE UNIT BOX PACKAGING—WORDING ON THE FRONT: “LAMP LITE”; “SINGLE LAMP—CEILING HUNG ACCENT LAMP”, and, IN SMALLER POINT SIZE TYPE: “INDIVIDUAL PIECES SLOT TOGETHER EASILY”. WORDING ON THE BACK, IN SMALLER POINT SIZE TYPE: “SINGLE LAMP INCLUDES THESE PIECES. CORNER AND DOUBLE LAMP ALSO AVAILABLE”. LOGO “LAMP LITE” ON THE BACK, ALSO.

Drawing PAGE 08—COLOR PHOTOGRAPH OF SINGLE UNIT BOX PACKAGING.

Drawing PAGE 09—COLOR PHOTOGRAPH OF SINGLE UNIT BOX PACKAGING.

Drawing PAGE 10—White cardstock model of SINGLE UNIT, assembled. The size of the lightbulb in relation to the fixture body is visible.

Drawing PAGE 11—White cardstock model of SINGLE UNIT, assembled. The cardstock model shows the positive/negative aspect of light/dark in the fixture body design.

The regular, equal spacing of the metal pieces, and modular shapes of the pieces imply the significance of the open/closed idea in the lamp fixture body.

Other lamp accessories can be added to the lamp fixture body: “the clapper”, which is a hand clapping on/off switch for a light fixture; the lamp can be plugged into outlets/sockets that will allow the bulb to be dimmed and/or automatically turned on/off; etc.

ADDITIONALLY, I AM INCLUDING THREE COLOR COPIES. These drawings show the use of the color brown in showing a shadowed, darkened or graying area that needs light in order for a person to see the area. The color yellow is included, also, as a neutral color, but is the other primary color used in print media.

Drawing PAGE 12—POSTCARD DESIGN FOR SINGLE UNIT—WORDING: “IF (color red)+(color green)+(color blue)=(color white) THEN (piece 1)+(piece 5)+(piece 4)=SINGLE UNIT”; “LAMP LITE . . . LIGHTING FOR THE FUTURE”; “SINGLE LAMP INCLUDES THESE PIECES. CORNER AND DOUBLE LAMPS ALSO AVAILABLE.”

Drawing PAGE 13—LOGO DESIGN FOR DOUBLE UNIT—WORDING: “LAMP LITE”; “DOUBLE LAMP”. The DOUBLE UNIT lamp is accurately rendered on this drawing.

Drawing PAGE 14—LOGO DESIGN FOR CORNER UNIT—WORDING: “LAMP LITE”; “CORNER LAMP”. The CORNER UNIT lamp is accurately rendered on this drawing.

Drawings 15-17 are 2001 black and white copies of the box model, not photographs.

Drawing PAGE 15—photocopy of box design—front

Drawing PAGE 16 photocopy of box design—back

Drawing PAGE 17 photocopy of box design—side

Drawings 18-21 are 5×7 color copy enlargements of 1990 photographic slides of three poster designs and the marketing literature.

Drawing PAGE 18 color copy of preliminary poster design—red and brown—actual size 9.25×16.5 inches.

Drawing PAGE 19 color copy of poster design—red and brown—actual size 8.25×16.5 inches.

Drawing PAGE 20 color copy of poster design—yellow and gray—actual size 8.5×17 inches.

Drawing PAGE 21 color copy of envelope, stationery, business card and logo for double lamp designs

Some Electrical Code Requirements:
“Ceiling” refers to structural ceiling, not hung, dropped, and/or suspended ceilings.
This lamp fixture body is not meant for a bathroom, laundry room or any wet area, or outdoors.
The light bulb socket wiring can be considered a ‘flexible cord or cable’.
The luminaire (lighting fixture), lampholder, or lamp can be classified under ‘Lighting Systems Operating at 30 volts or less’.
Wattage recommendation for single light bulb is 40 or 60 watts, maximum.
The simple, inexpensive lamp fixture body is meant for a residence such as a dormitory, and/or short-term and/or fast assembly/pre-assembled primary residential, home office, or commercial office setting.
This light fixture body was not meant for any ‘floating building’ or any moveable ‘recreational vehicles’.
Can be assembled and installed without assistance by one person—no previous electrical knowledge required.

Recommended finish: Platinum, if unpainted in a color, and steel is used.

Some Recommended Materials:

aluminum metal wires—lighter weight and easier to bend
steel wire—for the inside of the pieces, w/spacing based upon weight of wire
16 ga. galvanized wire, for suspended ceilings
3/32″ uncoated galvanized wire rope, plain—0.18/foot
aluminum joint rods—lighter weight and easier to bend
steel metal joint rods—more common and stronger and durable, longer lasting
round rod ⅛ inch×3 foot brass—$2.93
**round rod ⅛ inch×3 foot plain—$1.98 PREFERRED
light bulb socket/cord/plug for outlet assembly

### Westinghouse Bottle Adapter Carded Lamp Part—$6.98

light bulb
GE Reveal soft white 60 or 40

### GE Halogen 2 yr

N:Vision (60)14 watt, mini-spiral 10,000 hr
N:Vision (40) 9 watt, mini-spiral
T4 GY6-35 Halogen bi-pin base, 35w max—$6.00
ceiling hanger

### Swag Hooks—$1.97

separate light bulb socket
wing nut—0.98/bag
cap nut—0.98/bag

### Westinghouse Porcelain Socket Adapter Kit—$5.94

### Westinghouse Socket—$3.97

separate cord or cable
#2 decor chain—0.75/foot
#4 decor chain—0.79/foot #16 decor chain—0.48/foot

### 40″ White Hide A Cord—$4.98

### Westinghouse 15′ Gold Cord Set w/ Plug Carded Lamp Part—$4.67

Westinghouse White Ceiling Fan Swag Kit, for lighting fixtures—$9.97
10′ Vintage Brass 9 gauge Chain for high ceilings accessory—$60
separate electrical plug for wall outlet or other accessories
Westek touch control Lamp Dimmer, screw-in—$9.97
Occupancy Sensor Wall Switch—white—$91.50

For grouping of fixtures:

Alpha trak ext. 50w Electrical Transformer—(300w flex track electronic transformer—$236.40)
Alpha trak Monopoint—$78.00
Alpha trak Fixture Adapter—$30.00
Pendant Kit for suspending track with power feed—
Cord Extender for high ceilings—(stem extension kit with 2-12″ and 2-15″ stems included—$102.00)
Stem Kit for cord—hung Mini-Pendant—$73.50

For covering of the steel or aluminum or steel and aluminum fixture body:

**thin white acrylic sheet or lightweight clear plastic sheet cut to size to cover pieces, with wax or glue joint at the edges. PREFERRED

1. I have invented an ornamental body for a hanging light fixture that is groupable, and has six, interchangeable between the three units, pieces that slot and join together; thereby, making a corner unit possible, as well as a single and/or double unit. So, there are three body units. These body units are boxed separately. I have included a box, posters, business card, postcard, logo and envelope design, which were produced to market the hanging lighting fixture body, covered under U.S. Copyright. Maybe, the pieces could be sold separately, each in its own numbered box, from one to six. The design of those boxes would be similar in typeface, logo, coloring and size to the box design shown on the application drawings.
The design is for any ordinary light bulb and light socket, and any kind of cord, that can run to an outlet or electrical source. The cord must be sturdy enough not to tear or expose electrical wiring while being suspended from a ceiling, or horizontal, overhead surface. I saw existing patents for mounting and hanging brackets and methods; mounting rail and assembly; flexible hanger; fixture support and mount; electrical connectors in my search. This needs no further explanation.
Lamp Lite is lighting that you design. You can choose any combination of six individual pieces, and build your own light—either style Single, style Double, or style Corner. The single unit box contains one #1 piece, one #4 piece and one #5 piece to make up the body. The double unit box contains two #1 pieces, one #2 piece, two #4 pieces, and two #6 pieces. The corner, or third, unit box contains two #3 pieces, one #1 piece, one #2 piece, one #4 piece and one #6 piece.
The color is integral to the design. The number of units, which is three, corresponds to the three primary colors in white light found on computers. and television. The three colors of the six designed body pieces, comprising the three coded units, are red, green, and blue, around a simple, white light bulb. This reflects the importance of the white light found on computers, created from red, green and blue colors. In print media, the combination of all colors, or the primary colors red, yellow and blue, is black. On the computer, the combination of these three primary colors, or R (red) 255, G (green) 255, B (blue) 255, is white. To get a black color on a computer, one must remove all three primary colors, down to 0,0,0. See any computer primer.
I built a scale model of metal, copper pieces, and a rough, scale model of white cardstock. The weight of the metal, soldered or molded pieces is important. The sturdier and less pliant the metal, the stronger the configuration of the slotted and jointed pieces.
I did not study greatly, with any other metal, the metal joints. Of importance, for example, is the joint between pieces #4 and #5, where the two pieces come together at a 90 degree angle. The two metal pieces can join together by interlocking—where one piece—the vertical—would have a positive joint, and the other piece—a horizontal—would have a negative joint.
There could be a metal cover for the joint, or an additional metal thread that holds the joint together. This joint design would be for all joints. The joints exist between piece #1 and piece #2; between piece #3 and piece #2; and between piece #3 and piece #3 in the corner unit. In the double unit, the joints exist between the two separated pieces #1 and piece #2 between them; between piece #6 and piece #4 twice; between piece #6 and piece #6. There is only one joint in the single unit, which exists between piece #4 and piece #5. In this application, a wrappable metal rod insert, stabilizing piece at the 180 degree joints is designed and detailed, with a metal rod insert stabilizing piece at the 90 degree joints.
The three style units could be coded to the three colors in different ways. The primary emphasis is on a white light. The product, package design, and other marketing materials were coded this way: Red for the Single style unit; Green for the Double style unit; and Blue for the Corner style unit. The light body itself was created from copper metal material I bought at a hardware store on Myrtle Avenue in Brooklyn, New York. For example, in a specialized, more expensive Lamp-Lite product, the corner unit may be chosen to be red in color, the single unit may be green, and the double unit may be blue. The complexity of the units, in this application, follows the known color combination for white light—RGB, or red, green, blue.
The metal could be spray-painted in either red, blue or green to correspond appropriately to the style of the unit. Copper is a conducting metal, and I don't suggest the use of copper metal in the final product, in any way. The metal could be covered with a waterproof, non-lead base paint. Also, the metal could be covered with a substance to stop the aging and/or corroding process. Because these options are important, all of them will be applied to the product—corresponding color of waterproof, non-lead based paint over galvanized steel rods and wires.
